(19) United States
(12) Patent Application Publication
(10) Pub. No.: US 2004/0234793 A1
(43) Pub. Date: Nov. 25, 2004

(54) Glazing prelaminates, glazing laminates, and methods of making same

(75) Inventors: Peter T. Dietz, Eagan, MN (US); Dennis O. Falaas, Stillwater, MN (US); Heather K. Kranz, Blaine, MN (US); Brian L. Koster, Mendota Heights, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/881,067

(22) Filed: Jun. 29, 2004

Related U.S. Application Data
(63) Continuation of application No. 10/486,601, filed on Feb. 6, 2004, now abandoned.
Application No. 10/486,601 is a 371 of international application No. PCT/US02/25837, filed on Aug. 14, 2002.
(60) Provisional application No. 60/313,186, filed on Aug. 17, 2001.

(51) Int. Cl. B32B 27/00

(52) U.S. Cl. 428/461; 428/500; 427/150; 427/255.13

(57) ABSTRACT

Glazing prelaminates and glazing laminates for vehicular and architectural applications are described. The glazing prelaminate includes a functional film adhered to a shock dissipating layer with an adhesive region between the functional film and the shock dissipating layer. The adhesive region contains a reacted organic titanate primer. The glazing prelaminate can be prepared at temperatures lower than about 120 ° F. (49° C.). Methods of preparing the glazing prelaminate and the glazing laminate are provided.

### RELATED APPLICATIONS

The present application is a continuation of U.S. patent application Ser. No. 10/486,601, filed on Feb. 6, 2004, which was a national stage filing under 35 U.S.C. 371 of PCT/US02/25837, filed on Aug. 14, 2002, which International Application was published by the International Bureau in English on Feb. 27, 2003, which claims priority to U.S. Provisional Application No. 60/313,186 filed on Aug. 17, 2001 and which has expired.

### FIELD OF THE INVENTION

The present invention relates to glazing prelaminates and glazing laminates. More particularly, the invention relates to glazing laminates and glazing prelaminates that are prepared using an organic titanate primer.

### BACKGROUND OF THE INVENTION

Conventional automotive and architectural glazing laminates typically include an energy absorbing or shock dissipating layer of plasticized poly(vinyl butyral) (PVB) between two transparent sheets of glass- or plastic. The glazing laminates are prepared by placing the PVB layer between the glass, eliminating air from the engaging surfaces, and then subjecting the assembly to an elevated temperature and pressure in an autoclave to fusion bond the PVB and the sheets of glass or plastic. Such glazing laminates have also included a functional film engineered to enhance the performance of a window containing the glazing laminate. For example, functional films have been used to improve the safety of the glazing laminate or to reduce entry of infrared radiation through the glazing laminate into a vehicle or building.

Glazing prelaminates are prepared by adhering a functional film to one or more layers of PVB. The glazing prelaminates are bonded to one or more transparent sheets of glass or plastic to form vehicular or architectural glazing laminates.

Conventional manufacturing processes used to prepare glazing prelaminates typically involve heating the PVB in the range of about 120° F. (49° C.) to about 150° F. (66° C.). At these temperatures, the PVB softens, becomes tacky, and adheres to the functional film. The adhesive strength is typically sufficient to keep the PVB and the functional film together during the subsequent steps involved in forming a glazing laminate from the glazing prelaminate. The processes have been limited to line speeds of about 15 ft/min (8 cm/sec).

### SUMMARY OF THE INVENTION

The present invention provides glazing prelaminates and glazing laminates for vehicular and architectural applications. Other aspects of the invention provide efficient methods for making glazing prelaminates and glazing laminates. In particular, both glazing prelaminates and glazing laminates are prepared using an organic titanate primer.

In one aspect, the invention provides a method of making a glazing prelaminate. The method involves providing an organic titanate primer between a functional film and a shock dissipating layer, and adhering the functional film to the shock dissipating layer.

In a second aspect, the invention provides a glazing prelaminate. The glazing prelaminate includes a functional film adhered to a shock dissipating layer with an adhesive region between the functional film and the shock dissipating layer. The adhesive region contains a reacted organic titanate primer.

In a third aspect, the invention provides a method of making a glazing laminate. The method involves providing an organic titanate primer between a functional film and a shock dissipating layer, adhering the functional film to the shock dissipating layer, and bonding a transparent substrate to the shock dissipating layer such that the shock dissipating layer is between the functional film and the transparent substrate.

In a fourth aspect, the invention provides a glazing laminate. The glazing laminate includes a functional film adhered to a shock dissipating layer with an adhesive region between the functional film and the shock dissipating layer. The adhesive region contains a reacted organic titanate primer. A transparent substrate is bonded to the shock dissipating layer such that the shock dissipating layer is between the functional film and the transparent substrate.

The glazing prelaminates can typically be prepared at lower temperatures than used with conventional processes that do not include an organic titanate primer. For example, the glazing laminates can be prepared at temperatures less than about 120° F. (49° C.). In some embodiments, the glazing prelaminate can be prepared using manufacturing line speeds up to 10 times faster than those that can be used to prepare such an article in the absence of an organic titanate primer.

### BRIEF DESCRIPTION OF THE DRAWINGS

FIG. 1 is a schematic exploded, cross sectional view of various elements that can be included in a glazing prelaminate or glazing laminate. The surface of the functional film is treated with an organic titanate primer.

FIG. 2 is a schematic exploded, cross sectional view of various elements that can be included in a glazing prelaminate or glazing laminate. An adhesive region containing a reacted organic titanate primer is between the functional film and the shock dissipating layer.

### DETAILED DESCRIPTION OF THE INVENTION

The present invention provides glazing prelaminates and methods of making glazing prelaminates. The glazing prelaminates include a functional film adhered to a shock dissipating layer with an adhesion region between the functional film and the shock dissipating layer. The adhesion region contains a reacted organic titanate primer. The invention also provides glazing laminates and methods of making glazing laminates. The glazing laminates include in the following order a transparent substrate, a shock dissipating layer, an adhesion region containing a reacted organic titanate primer, and a functional film. The glazing laminates can be used in vehicular or architectural applications.

The glazing prelaminates of the present invention can be prepared at lower temperatures than used with conventional processes that do not include an organic titanate primer. The lower temperatures allow the use of higher line speeds than have been used with conventional processes to from glazing prelaminates.

In one aspect, the invention provides a method of making a glazing prelaminate. The method involves providing an organic titanate primer between a functional film and a shock dissipating layer, and adhering the functional film to the shock dissipating layer.

The functional film includes, for example, safety film, infrared reflective film, ultraviolet reflective film, polarizing film, anti-intrusion film, and the like. The functional film can function as on optical filter. In some embodiments, the functional film can be metallic, colored, dyed, pigmented, or tinted. Examples of suitable metallic films are described in U.S. Pat. No. 5,091,258. Examples of suitable pigmented films are described in WO 01/58989. The functional film can have a monolithic or multi-layer construction. Examples of suitable multi-layer films are described in WO 01/96104 and U.S. Pat. No. 5,877,895, incorporated herein by references.

Functional films having a multi-layer construction can include, for example, layers or coatings that serve mechanical, chemical, optical, barrier, or adhesive purposes. For example, one or more layers of a multi-layer functional film can provide tear resistance, abrasion resistance, slip or anti-blocking, ultraviolet absorption, fluorescence, weatherability, holographics, optical diffusion, resistance to permeation by liquids and vapors, or resistance to diffusion by liquids or vapors. Such multi-layer films are described in U.S. Pat. No. 6,368,699, incorporated herein by reference.

The functional film is typically transparent. As used herein, the term “transparent” refers to materials that allow at least some amount of light to pass through the materials. In some embodiments, transparent materials allow greater than 25 percent, greater than 50 percent, greater than 75 percent, greater than 90 percent, greater than 95 percent, or 100 percent of the light to pass through the materials.

The surface of the functional film typically contains, for example, a polyacrylate, a polyester, an ionomer, a cellulose acetate, or a combination thereof.

As used herein, the term “polyacrylate” includes a polymer or a copolymer prepared from alkyl acrylate monomers, acrylic acid monomers, alkyl methacrylate monomers, methacrylic acid monomers, acrylonitrile monomers, or like monomers. The alkyl group typically contains up to about 20 carbon atoms. In some embodiments, the alkyl group contains up to 12 or up to 6 carbon atoms. Suitable alkyl groups include methyl, ethyl, propyl, butyl, and the like.

As used herein, the term “polyester” includes a polymer or copolymer prepared by reacting at least one type of dicarboxylic acid or ester with at least one type of diol. In some embodiments, suitable polyesters include, for example, polyethylene terephthalate (PET), polyethylene 2,6-naphthalate (PEN), polyethylene isophthalate, polycarbonate, polybutylene terephthalate (PBT), and polybutylene 2,6-naphthalate (PBN).

Suitable dicarboxylic acid for preparing polyesters include, but are not limited to, terephthalic acid, isophthalic acid, phthalic acid, all isomeric naphthalenedicarboxylic acids (2,6-, 1,2-, 1,3-, 1,4-, 1,5-, 1,6-, 1,7-, 1,8-, 2,3-, 2,4-, 2,5-, 2,7-, and 2,8-), bibenzoic acids such as 4,4′-biphenyl dicarboxylic acid and its isomers, trans-4,4′-stilbene dicarboxylic acid and its isomers, 4,4′-diphenyl ether dicarboxylic acid and its isomers, 4,4′-diphenylsulfone dicarboxylic acid and its isomers, 4,4′-benzophenone dicarboxylic acid and its isomers, halogenated aromatic dicarboxylic acids such as 2-chloroterephthalic acid and 2,5-dichloroterephthalic acid, other substituted aromatic dicarboxylic acids such as tertiary butyl isophthalic acid and sodium sulfonated isophthalic acid, cycloalkane dicarboxylic acids such as 1,4-cyclohexanedicarboxylic acid and its isomers and 2,6-decahydronaphthalene dicarboxylic acid and its isomers, bi- or multi-cyclic dicarboxylic acids (such as the various isomeric norbornane and norbornene dicarboxylic acids, adamantane dicarboxylic acids, and bicyclo-octane dicarboxylic acids), alkane dicarboxylic acids (such as sebacic acid, adipic acid, oxalic acid, malonic acid, succinic acid, glutaric acid, azelaic acid, and dodecane dicarboxylic acid.), and any of the isomeric dicarboxylic acids of the fused-ring aromatic hydrocarbons (such as indene, anthracene, pheneanthrene, benzonaphthene, fluorene and the like). Alternatively, alkyl esters of these monomers, such as dimethyl terephthalate, may be used.

Suitable diols for preparing polyesters include, but are not limited to, linear or branched alkane diols or glycols (such as ethylene glycol, propanediols such as trimethylene glycol, butanediols such as tetramethylene glycol, pentanediols such as neopentyl glycol, hexanediols, 2,2,4-trimethyl-1,3-pentanediol and higher diols), ether glycols (such as diethylene glycol, triethylene glycol, and polyethylene glycol), chain-ester diols such as 3-hydroxy-2,2-dimethylpropyl-3-hydroxy-2,2-dimethyl propanoate, cycloalkane glycols (such as 1,4-cyclohexanedimethanol and its isomers and 1,4 -cyclohexanediol and its isomers), bi- or multicyclic diols (such as the various isomeric tricyclodecane dimethanols, norbornane dimethanols, norbornene dimethanols, and bicyclo-octane dimethanols), aromatic glycols (such as 1,4-benzenedimethanol and its isomers, 1,4-benzenediol and its isomers, bisphenols such as bisphenol A, 2,2′-dihydroxy biphenyl and its isomers, 4,4′-dihydroxymethyl biphenyl and its isomers, and 1,3-bis(2-hydroxyethoxy)benzene and its isomers), and lower alkyl ethers or diethers of these diols, such as dimethyl or diethyl diols.

Tri- or polyfunctional monomers, which can serve to impart a branched structure to the polyester molecules, can also be used as comonomers. They may be of either the carboxylic acid, ester, hydroxy or ether types. Examples include, but are not limited to, trimellitic acid and its esters, trimethylol propane, and pentaerythritol. Also suitable as comonomers are monomers of mixed functionality, including hydroxycarboxylic acids such as parahydroxybenzoic acid and 6-hydroxy-2-naphthalenecarboxylic acid, and their isomers, and tri- or polyfunctional comonomers of mixed functionality such as 5-hydroxyisophthalic acid and the like.

As used herein, the term “ionomer” refers to an ion containing polymer or copolymer. A suitable ionomer includes poly(ethylene-co-methacrylic acid) commercially available from E.I. Dupont de Nemours & Co. (Wilmington, Del.) under the trade designation SURLYN. Other ionomers are commercially available from Exxon Chemical (Houston, Tex.) under the trade designation IOTEK and Network Polymers (Akron, Ohio).

As used herein, the phrase “cellulose acetate” refers to a polymer of copolymer containing acetate esters of cellulose. The cellulose acetate can be a diacetate or a triacetate.

The functional film is adhered to a shock dissipating layer. The shock dissipating layers imparts a protective feature to vehicular and architectural glazing laminates. As used herein, the phrase “shock dissipating” includes layers that are energy absorbing. Shock dissipating layers typically include, but are not limited to, poly(vinyl butyral) (PVB). PVB is commercially available as a film from, for example, E.I. DuPont deNemours, Co., (Wilmington, Del.) under the trade designation BUTACITE, Solutia Inc. (St. Louis, Mo.) under the trade designation SAFLEX, H. T. Troplast (Germany) under the trade designation TROSIFOL, and Sekisui (Japan) under the trade designation S-LEC.

In some embodiments, the shock dissipating layer has a textured surface. The texture defines channels that can allow air to escape when the shock dissipating layer is adhered to the functional film.

An organic titanate primer is provided between the functional film and the shock dissipating layer. The organic titanate primer can be applied to either the shock dissipating layer or the functional film. The organic titanate primer comprises a tetra-alkyl titanate, a titanate chelate, or a combination thereof. Suitable organic titanate compounds are available from E.I. DuPont de Nemours & Co. (Wilmington, Del.) under the trade designation TYZOR and from Akzo Nobel (The Netherlands).

Suitable tetra-alkyl titanates include alkyl groups having about 2 to about 10 carbon atoms. Specific tetra-alkyl titanates include, for example, tetra-ethyl titanate, tetra-n-propyl titanate, tetra-isopropyl titanate, tetra-n-butyl titanate, n-butyl titanate polymer, tetra-2-ethylhexyl titanate, and combinations thereof. The alkyl group can be substituted with one or more hydroxy groups. An example of an organic titanate having an hydroxy substituted alkyl group is tetra-(octylene glycol) titanate.

Suitable titanate chelates include, for example, titanium acetylacetonate, titanium ethylacetoacetate, titanium tetrabutanolate polymer, and combinations thereof.

The organic titanate primer can be applied to either the functional film or the shock dissipating layer in a neat form or in the form of a primer solution. In some embodiments, use of an organic titanate primer in a neat form can cause the glazing prelaminate or glazing laminate to appear hazy or opaque. The primer is typically diluted in a solvent to form a primer solution. In some embodiments, the organic titanate can be present in the primer solution at concentrations up to about 10 weight percent. The concentration of organic titanate in the primer solution is typically at least about 0.1 weight percent. For example, the concentration of the organic titanate can be in the range of about 0.1 to about 10 weight percent, about 0.1 to about 5 weight percent, or about 0.1 to about 1 weight percent of the primer solution.

The solvent for the primer solution can vary depending on the composition of the functional film and the shock dissipating layer, the organic titanate primer composition, and the application conditions. Suitable solvents include aliphatic hydrocarbons, aromatic hydrocarbons, alcohols, esters, ketones, or combinations thereof. Specific examples of suitable solvents include methanol, ethanol, isopropanol, butanol, ethylacetate, acetone, hexane, heptane, and toluene. In some embodiments, the solvent is an alcohol such as methanol, ethanol, isopropanol, butanol, or a combination thereof.

The primer solution can be applied to the functional film or the shock dissipating layer. A layer of reacted organic titanate primer forms. In some embodiments, the organic titanate primer undergoes hydrolysis, or hydrolysis and condensation. The reaction product depends on the temperature, the organic titanate composition, and the amount of water present. Water favors the hydrolysis of the organic titanate primer. Tetra-alkyl titanates typically hydrolyze more rapidly than titanate chelates. Typically, the higher the molecular weight of the alkyl group, the slower the hydrolysis rate of the tetra-alkyl titanate. If the organic titanate primer hydrolyzes too rapidly, the glazing prelaminate can appear hazy.

The primer solution is typically dried prior to adhering the functional film to the shock dissipating layer. The solvent in the organic titanate primer solution can be evaporated leaving a coating or layer of the reacted primer on the surface of the functional film or the shock dissipating layer. The reacted organic titanate primer can be present in an amount of about 1 μg/in² (0.2 μg/cm²) to about 30 μg/in² (5 μg/cm²). In some embodiments, the reacted organic titanate primer includes titanium dioxide, titanium dioxide hydrate, a polymer of titanium dioxide, or a combination thereof. The reacted titanate primer can be amorphous and form a clear, continuous or discontinuous coating on the surface of the functional film or the shock dissipating layer.

One embodiment of the invention provides a method of making a glazing prelaminate that includes applying a first organic titanate primer to a first surface of a functional film to form a first treated surface. The first treated surface of the functional film is contacted so as to adhere with a first shock dissipating layers.

In another embodiment of the method of making a glazing prelaminate, the functional film is treated on a first surface with a first organic titanate primer and on a second surface opposite the first surface with a second organic titanate primer. The organic titanate primers used to treat the first and second surfaces can be the same or different. The method includes contacting so as to adhere the first treated surface of the functional film to a first shock dissipating layer and contacting so as to adhere the second treated surface of the functional film to a second shock dissipating layer. The first and second shock dissipating layers can be the same or different. The functional film is sandwiched between the two shock dissipating layers.

Typically, the functional film and the shock dissipating layer are polymeric films that are available in roll form. The process of preparing the glazing prelaminate can be continuous or non-continuous. In a continuous process, the application of the organic titanate primer to the functional film or the shock dissipating layer is in-line with the process for adhering the functional film to the shock dissipating layer. In a non-continuous process for preparing the glazing prelaminate, the application of the organic titanate primer is conducted separately from the process of adhering the functional film to the shock dissipating layer.

The organic titanate primer solution can be applied to the functional layer or the shock dissipating layer using a variety of methods including, but not limited to, spraying, roll coating, or dipping. In some embodiments, the mode of application provides an even coating in a pre-metered manner. In one example, the organic titanate primer is applied using a gravure roll.

The shock dissipating layer can be prepared in-line or supplied as a previously prepared roll of film. To keep the shock dissipating layer from sticking to itself when supplied as a roll of film, an optional release liner can be used and removed prior to adhering the shock dissipating layer to the treated functional film. In another embodiment, the shock dissipating layer can be supplied as a film in a form without a liner and maintained at about 10° C. Cooling decreases the tackiness of the shock dissipating layer and keeps the shock dissipating layer from sticking to itself.

If the shock dissipating layer is cooled, moderate heating may be desirable prior to adhering this layer to the functional film. Heat can be provided using, for example, radiant, conductive, or convective heat. In one embodiment, an infrared heater is positioned on one or both sides of the shock dissipating layer after it has been unrolled. In another embodiment, the unrolled shock dissipating layer can be passed over a heated roll to increase the temperature of the layer. Alternatively, or in addition to the heating the shock dissipating layer, the functional layer can be heated.

The functional film and the shock dissipating layer can be adhered by rolling both the functional film and the shock dissipating layers together on the same roll or by pass them through one or more sets of rollers. Glazing prelaminates that include an organic titanate primer provided between the functional film and the shock dissipating layer can be prepared at temperatures less than about 120° F. (49° C.). In some embodiments, the glazing prelaminates can be formed at temperature less than about 100° F. (38° C.) or less than about 80° F. (27° C.). For example, the glazing prelaminates of the present invention can be prepared at a temperature in the range of about 50° F. (10° C.) to about 100° F. (38° C.) or in the range of about 60° F. (16° C.) to about 80° F. (27° C.).

The glazing prelaminates can be formed at line speeds up to 10 to 30 times faster than such an article can be prepared without the use of the organic titanate primer between the functional film and the shock dissipating layer. The line speeds are typically greater than about 2 ft/min (1 cm/sec) or greater than about 10 ft/min (5 cm/sec. In some embodiments, the line speeds for preparing glazing prelaminates of the invention can be greater than 15 ft/min (8 cm/sec). Line speeds up to about 100 ft/min (50 cm/sec), up to about 150 ft/min (75 cm/sec), or up to about 300 ft/min (150 cm/sec) can be used. For example, the line speed can be in the range of about 2 ft/min (1 cm/sec) to about 300 ft/min (150 cm/sec), about 10 ft/min (5 cm/sec) to about 150 ft/min (75 cm/sec), or about 15 ft/min (8 cm/sec) to about 100 ft/min (50 cm/sec). In other embodiments, line speeds in the range of about 2 ft/min (1 cm/sec) to about 100 ft/min (50 cm/sec) can be used.

Optionally, pressure can be applied to form the glazing prelaminate of the invention. For example, a nip roll apparatus, a pressurized chamber, or a platen can be used to apply pressure. In some embodiments, the pressure is about 15 lbs/in (269 kg/m) to about 100 lbs/in (1790 kg/m).

The adhesive strength of the glazing prelaminate can be sufficient to keep the functional film and the shock dissipating layers from separating during further processing and handling. For example, the adhesive strength between the treated surface of the functional film and the shock dissipating layer is in the range of about 10 to about 50 N/m, about 10 to about 100 N/m, or about 10 to about 300 N/m, as measured using the 180 degree T-peel test set forth below.

In some embodiments of a glazing prelaminate, a portion of the functional film is removed near the outer edges of the glazing prelaminates. Examples of such a technique are in U.S. patent application Ser. No. 10/038,642, which is incorporated by reference herein, in its entirety. The functional film and the shock dissipating layers can be partially separated without damaging either the functional film or the shock dissipating layer.

The process conditions can be varied to adjust the adhesion between the different layers of the glazing prelaminate. Lower adhesive strengths can be obtained, for example, by decreasing the pressure applied to the layers during the adhesion process, by operating at lower film and ambient temperatures, by decreasing the amount of organic titanate primer provided between the functional film and the shock dissipating layer, and by increasing the line speed (e.g., decreasing the dwell time).

In some embodiments, a shock dissipating layer having a textured surface is used to decrease the adhesive strength of the glazing prelaminate. Textured surfaces can be used advantageously with the relatively low temperatures used to prepare the glazing prelaminates of the invention. The textured surface can be retained at temperatures up to about 100° F. (38° C.). A glazing prelaminate can be formed in which only a portion of the shock dissipating layer adheres to the functional film. For example, in a shock dissipating layer having a surface textured with convex and concave regions, a glazing prelaminate can be formed in which the shock dissipating layer adheres to the functional film only in the convex regions. The functional film can typically be removed from the outer portions of the glazing prelaminate prior to forming a glazing laminate.

Following the adhesion step, the glazing prelaminate can optionally be placed on an x-y table and cut to fit a particular pattern for incorporation into a vehicular or architectural glazing laminate. The cutting step and the adhesion step to be conducted in-line or at the same location, which reduces the processing costs for preparing the glazing prelaminate.

A second aspect of the invention provides a glazing prelaminate. As shown in FIG. 2, the glazing prelaminate includes a functional film 830 adhered to a shock dissipating layer 810 with an adhesive region 820 between the functional film and the shock dissipating layer. The adhesive region contains a reacted organic titanate primer.

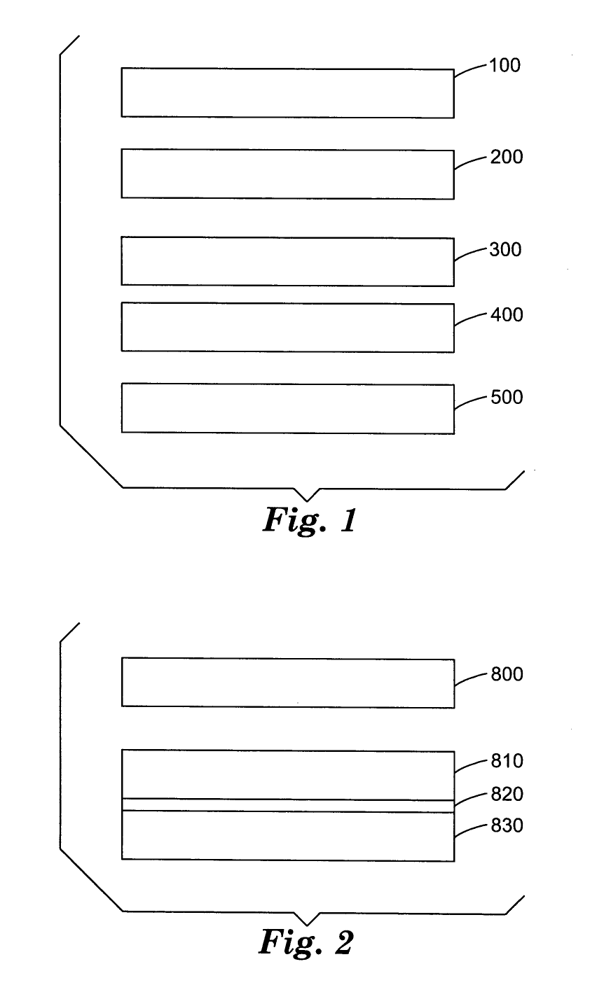

In one embodiment of the glazing prelaminate shown in FIG. 1, the glazing prelaminate includes a functional film 400 having a first surface treated with a first organic titanate primer to form a first treated surface 300. A shock dissipating layer 200 is adhered to the treated surface of the functional film.

In another embodiment of the glazing prelaminate shown in FIG. 1, the functional film 400 has a first surface treated with a first organic titanate primer to form a first treated surface 300 and a second surface, opposite the first surface, treated with a second organic titanate primer to form a second treated surface 500. The first and second organic titanate primer can be the same or different. A first shock dissipating layer 200 is adhered to the first treated surface of the functional film and a second shock dissipating layer 600 is adhered to the second treated surface of the functional film. The treated functional film is sandwiched between two shock dissipating layers.

In a third aspect, the invention provides a method of making a glazing laminate. The method involves providing an organic titanate primer between a functional film and a shock dissipating layer, adhering the functional film to the shock dissipating layer, and bonding a transparent substrate to the shock dissipating layer such that the shock dissipating layer is between the functional film and the transparent substrate.

The transparent substrate can be prepared from glass, polycarbonate, polyacrylate, or any other material having the properties desired for the particular application. The transparent substrate can be rigid or flexible and can be flat or curved.

In one embodiment, the glazing laminate can be formed by applying a first organic titanate primer to a first surface of a functional film to form a first treated surface of the functional film, contacting so as to adhere the first treated surface of the functional film with a first shock dissipating layer, and bonding a first transparent substrate to the first shock dissipating layer. The first shock dissipating layer is sandwiched between the first transparent substrate and the first treated surface of the functional film.

In another embodiment, the functional film is treated on a first surface with a first organic titanate primer and on a second surface, opposite the first surface, with a second organic titanate primer. The organic titanate primer used to treat the first and second surfaces can be the same or different. The method involves contacting so as to adhere the first treated surface of the first functional film with a first shock dissipating layer and contacting so as to adhere the second treated surface of the functional film with a second shock dissipating layer. The first and second shock dissipating layers can be the same or different. The functional film is sandwiched between the two shock dissipating layers. The first shock dissipating layer is bonded to a first transparent substrate and the second shock dissipating layer is bonded to a second transparent substrate such that the shock dissipating layers are between the treated functional film and the transparent substrates.

The bonding of the transparent substrate to the shock dissipating layer can involve the application of heat, pressure, or a combination thereof. For example, an autoclave can be use to form the glazing laminate. In some embodiments, the autoclave conditions include temperatures up to about 150° C., pressure up to about 200 psi (1400 kPa), and cycle times up to about 120 minutes. For example, the glazing laminate can be autoclaved at a temperature in the range of about 130° C. to about 150° C. and at a pressure in the range of about 170 psi (1190 kPa) to about 200 psi (1400 kPa) for about 60 minutes to about 120 minutes. After bonding, the glazing laminate can have an adhesive strength between the functional film and the shock dissipating layer in the range of about 10 to about 300 N/m or in the range of about 10 to about 700 N/m using a 180 degree T-peel test.

In some embodiments, the glazing laminate can be prepared from a glazing prelaminate. In other embodiments, the shock dissipating layer can be bonded to the transparent substrate prior to adhereing the shock dissipating layer to the functional film.

In a fourth aspect, the invention provides a glazing laminate. As shown in FIG. 2, the glazing laminate includes a functional film 830 adhered to a shock dissipating layer 810 with an adhesive region 820 between the functional film and the shock dissipating layer. The adhesive region contains a reacted organic titanate primer. The shock dissipating layer is bonded to a transparent substrate such that the shock dissipating layer is between the functional film and the transparent substrate.

In one embodiment shown in FIG. 1, the glazing laminate includes a functional film 400 having a first surface treated with a first organic titanate primer to form a first treated surface 300. A first shock dissipating layer 200 is adhered to the first treated surface of the functional film. A transparent substrate 100 is bonded to the first shock dissipating layer such that the shock dissipating layer is between the functional film and the first transparent substrate.

In another embodiment shown in FIG. 1, the glazing laminate includes a functional film 400 having a first surface treated with a first organic titanate primer to form a first treated surface 300 and a second surface treated with a second organic titanate primer to form a second treated surface 500. The first and second organic titanate primer can be the same or different. A first shock dissipating layer 200 is adhered to the first treated surface of the functional film and a second shock dissipating layer 600 is adhered to the second treated surface of the functional film. The first and second shock dissipating layer can be the same or different. A first transparent substrate 100 is bonded to the first shock dissipating layer and a second transparent substrate 700 is bonded to the second shock dissipating layer. The first shock dissipating layer is between the functional film and the first transparent substrate and the second shock dissipating layer is between the functional film and the second transparent substrate.

### EXAMPLES

Test Methods

180 degree T-peel Test

The 180 degree T-peel test, used to measure the adhesive strength, was conducted at 73.4±3.6° F. (23±2° C.) using a MTS force tester or equivalent having a 200 pound (0.91 kg) load cell. The glazing prelaminate was cut into 1″×8″ (2.5 cm×20.3 cm) strips. Approximately 1 in (2.5 cm) of the glazing prelaminate was carefully separated by hand to allow for mounting to the pneumatic grips of the force tester. The shock dissipating layer was clamped in the lower MTS pneumatic grip and the functional film was clamped in the upper MTS pneumatic grip. The distance between the grips was two inches. The crosshead speed was set to 12 in/min (30.5 cm/min). The total pull length was 100 mm (3.9 in) and the data was collected starting at 25 mm (1 in) and ending at 100 mm (3.9 in). The average peel force was recorded. The test was repeated with two other samples. The average of the three samples was recorded.

Film Temperature

The temperature of the film was measured with an infrared pyrometer.

### Example 1

A functional film, designated SRF, was treated with a primer solution containing tetra-isopropyl titanate. The functional film was an infrared reflecting multilayered polymeric film, described in U.S. patent application Ser. No. 09/590,924 and having a thickness of approximately 51 μm. The functional film was coated with a 0.5 wt % solution of Dupont TYZOR (tetra-isopropyl titanate “TPT”) in isopropyl alcohol. The primer solution was prepared in a 55 gallon drum equipped with a drum mixer to mix the TYZOR into the isopropyl alcohol. After mixing, the primer solution was transported to a gravure coater where a 150 line gravure roll was used to apply the organic titanate primer solution to the functional film. The coated functional film was pulled through a ten foot long oven heated to 66° C. to dry, at 120 ft/min (61 cm/sec). Both sides of the functional film were coated as described above.

The organic titanate primer treated functional film was laminated to a 15 mil PVB layer (SAFLEX AR-11) available from SOLUTIA (St. Louis, Mo.) using a two-roll rubber coated nip roll having a durometer of about 60-65. The gap between the rollers was 0.0 in (0.0 cm). The roller speed was approximately 100 ft/min (51 cm/sec). The materials and equipment were conditioned to 22° C.

Using the 180 degree T-peel test described above, the adhesive strength was 0.2 lb/in (35 N/m) between the treated surface of the functional film and the PVB layer.

### Comparative Example 2

Using the same pre-lamination conditions set forth in Example 1, film samples were individually treated as follows:

Unprimed polymeric infrared reflecting film (as described in U.S. patent application Ser. No. 09/590,924; referred to as SRF)

| | |
|---|---|
| Comp. Ex. 2-1 | Air corona treated SRF. |
| Comp. Ex. 2-2 | Nitrogen corona SRF |
| Comp. Ex. 2-3 | Dupont Melinex 454 PET film |

The 180 degree T-peel test results indicated that a measurable bond did not form.

### Example 3

To evaluate various primers and surface treatments in terms of their ability to bond to the smooth side of HT Troplast Trosifol PV3510 PVB at room temperature with moderate pressure, the following samples were prepared and tested:

| | |
|---|---|
| Ex. 3-1 | 0.125 wt % Tyzor TPT primed SRF |
| Ex. 3-2 | 0.5 wt % Tyzor TPT Primed SRF |
| Ex. 3-3 | 1 wt % Tyzor TPT primed SRF |
| Comp. Ex. 3-1 | Unprimed SRF |
| Comp. Ex. 3-2 | Air corona treated SRF |
| Comp. Ex. 3-3 | Nitrogen corona treated SRF |
| Comp. Ex. 3-4 | Dupont Melinex 454 film |

The primed film samples were mated up to the smooth side of HT Troplast Trosifol PV3510 PVB then passed through a rubber coated nip. The nip rolls were 4 in (10.2 cm) diameter, coated with 60-65 durometer rubber, the pressure on the nip was 95 psi (1700 kg/m) with 1 in (2.5 cm) diameter stacked air cylinders on both ends of the nip. The line speed was approximately 10 ft/min (5.1 cm/sec). The temperature of the room, films, and equipment was 21° C.

Only Tyzor TPT primed film (all concentrations) adhered to the smooth side of HT Troplast PV3510 PVB at these conditions. All other treatments and coatings did not enhance or allow a bond to form.

### Example 4

To evaluate various primers and surface treatments in terms of their ability to bond to the smooth side of Solutia Saflex AR-11 PVB at room temperature with moderate pressure, the following samples were prepared and tested:

| | |
|---|---|
| Ex. 4-1 | 0.125% Tyzor TPT primed SRF |
| Ex. 4-2 | 0.5% Tyzor TPT primed SRF |
| Ex. 4-3 | 1% Tyzor TPT primed SRF Unprimed SRF |
| Comp. Ex. 4-1 | Air corona treated SRF |
| Comp. Ex. 4-2 | Nitrogen corona treated SRF |
| Comp. Ex. 4-3 | Dupont Melinex 454 film |

The primed film samples were mated up to the smooth side of Solutia AR-11 PVB then passed through a rubber coated nip in an attempt to create a bond between the two films. The nip rolls were 4 inch (10.2 cm) in diameter, coated with 60-65 durometer rubber, the pressure on the nip was 95 psi (1700 kg/m) with 1 inch (2.5 cm) diameter stacked air cylinders on both ends of the nip).

The line speed was approximately 10 ft/min (5.1 cm/sec). The temperature of the room, films, and equipment was 21° C.

Only Tyzor TPT primed film (all concentrations) adhered to the smooth side of Solutia AR-11 PVB at these conditions. All other treatments and coatings did not enhance or allow a bond to form.

### Example 5

Tyzor TPT was evaluated as a primer to bond various polymeric films to PVB under low temperature and pressure conditions.

A 0.5 wt % solution of Tyzor TPT in methanol was prepared by placing 298.5 grams methanol and 1.5 grams of Tyzor TPT in a glass jar. The jar was capped and shaken for 30 seconds to mix the organic titanate in the methanol. Exposure to atmospheric moisture was minimized.

Each film sample was cut to 10 in×10 in (24.5 cm×25.4 cm) square. The sample was taped to a 12 in×12 in×¼ in (30.5 cm×30.5 cm×0.6 cm) thick glass plate. Three grams of the primer solution was dispensed on the center of the film. A soft polyester cloth was used to evenly spread the solution over the exposed surface of the film sample. Excess primer solution was absorbed by the polyester cloth. Immediately after coating, the film sample was placed into a 90° C. oven to dry for 2 minutes.

A laminate was prepared using a Basix B-400 laminator manufactured by Hix Corporation (Pittsburg, Kansas). The top plate temperature was set at 30° C. and a moderate pressure was used. A 6 in×8 in (15.2 cm×20.3 cm) piece of 15 mil Solutia RK-11 PVB was centered on the lower plate with the smoother side facing up. The film sample was centered on the PVB with the primed side facing the PVB. The press was closed for twelve seconds to bond the two components. After twelve seconds the press was opened and the sample removed.

After the films were laminated to 15 mil Solutia RK-11 PVB, the laminates were tested for 180 degree T-peel force.

TABLE 1
Evaluation of Various Functional Films

| Film | Thickness | Primer | 180° peel force (N/m) |
|---|---|---|---|
| SRF (PET) | 2 mil | TPT | 19 |
| SRF (PET) | 2 mil | none | 1 |
| SRF (PEN) | 2 mil | TPT | 20 |
| SRF (PEN) | 2 mil | none | 0 |
| SRF (PET) | 2 mil | Corona | 2 |
| Surlyn | 7 mil | TPT | 31 |
| Surlyn | 7 mil | none | 0 |
| Dupont melinex 454 | 4 mil | TPT | 28 |
| Dupont Melinex 454 | 4 mil | none | 1 |
| Polycarbonate | 7 mil | TPT | 19 |
| Polycarbonate | 7 mil | none | 0 |
| Acetate | 5 mil | TPT | 13 |
| Acetate | 5 mil | none | 0 |
| Polyethylene | 2 mil | TPT | 0 |
| Polyethylene | 2 mil | none | 0 |
| Polypropylene | 3 mil | TPT | 0 |
| Polypropylene | 3 mil | none | 0 |
| PVC | 4 mil | TPT | 0 |
| PVC | 4 mil | none | 0 |
| PFA | 2 mil | TPT | 0 |
| PFA | 2 mil | none | 0 |
| FEP | 2 mil | TPT | 0 |
| FEP | 2 mil | none | 0 |

PFA = perfluoroalkoxy fluorocarbon
FEP = fluorinated ethylene-propylene
PVC = plasticized polyvinyl chloride
Dupont melinex 454 = PET
PET = Polyethylene terephthalate
PEN = polyethylene naphthalene
Surlyn = Ionomer
Corona = 0.65 j/cm²
TPT = Tetraisopropyl titanate
Acetate = cellulose acetate

Tyzor TPT effectively performs as a primer/adhesion promoter to PVB at low temperatures and pressures for a variety of polymeric films. The PVB shock dissipating layer adhered to the following films with the use of the organic titanate primer: polyester (including PEN, PET, and polycarbonate), ionomer, and cellulose acetate.

### Example 6

A SRF film was coated with a 0.5% Tyzor TPT solution in IPA using a 150 line gravure roller and dried in an oven set at 150° F. (66° C.) (Example 6-1). Another sample of SRF film was not primed (Comparative Example 6-1). PVB was contacted to the primed and unprimed films without the use of a pressure applying nip roll.

The SRF functional film was contacted to the smooth side of Solutia AR-11 PVB shock dissipating layer by winding them together on the same core. The PVB was interleafed with a 1 mil textured polyethylene film to prevent blocking. The machine and materials were conditioned to 72° F. (22° C.). The machine used was an Orca graphics laminator running at 6 feet per minute. The winding torque was 35%. 50 meters of each sample was produced in this fashion. The sample material was stored at 72° F. (22° C.).

Three days later, the adhesive strength was measured using the 180 degree T-peel test. Only the organic titanate primer treated SRF film created a bond. The peel force was 15 N/m. The un-primed film did not form a measurable bond under these conditions.

From the above disclosure of the general principles of the present invention and the preceding detailed description of exemplary embodiments, those skilled in this art will readily comprehend the various modifications, re-arrangements and substitutions to which the present invention is susceptible. Therefore, the scope of the invention should be limited only by the following claims and equivalents thereof.

We claim:

1. A method of making a glazing prelaminate comprising:
applying a first organic titanate primer to a first surface of a functional film to form a first treated surface of the functional film; and
contacting so as to adhere together the first treated surface of the functional film and a first shock dissipating layer to form a glazing prelaminate.

2. The method of claim 1, wherein the first shock dissipating layer has a temperature of less than about 120° F. (49° C.) during said contacting.

3. The method of claim 1, wherein the first shock dissipating layer has a temperature in the range of about 50° F. (10° C.) to about 100° F. (38° C.) during said contacting.

4. The method of claim 1, wherein the first surface of the functional film comprises a polyester, polyacrylate, ionomer, cellulose acetate, or a combination thereof.

5. The method of claim 1, wherein the first surface of the functional film comprises a polycarbonate, polyethylene terephthalate, polyethylene isophthalate, polyethylene 2,6-naphthalate, polybutylene terephthalate, polybutylene 2,6-napthathalate, or a combination thereof.

6. The method of claim 1, wherein the functional film comprises an infrared reflective film, a ultraviolet reflective film, a safety film, a polarizing film, anti-intrusion film, or a combination thereof.

7. The method of claim 1, wherein the first shock dissipating layer comprises a poly(vinyl butyral).

8. The method of claim 1, wherein the first organic titanate primer hydrolyzes after said applying.

9. The method of claim 1, wherein the first organic titanate primer comprises a tetra-alkyl titanate, a titanate chelate, or a combination thereof.

10. The method of claim 1, wherein the first organic titanate primer comprises tetra-ethyl titanate, tetra-isopropyl titanate, tetra-n-propyl titanate, tetra-n-butyl titanate, n-butyl titanate polymer, tetra-2-ethylhexyl titanate, tetra-(octylene glycol) titanate, or a combination thereof.

11. The method of claim 1, wherein the first organic titanate primer comprises titanium acetylacetonante, titanium ethylacetoacetate, titanium tetrabutanolate polymer, or a combination thereof.

12. The method of claim 1, wherein the first organic titanate primer comprises tetra-isopropyl titanate.

13. The method of claim 1, wherein the first organic titanate primer is in the form of a primer solution comprising in the range of about 0.1 to about 10 weight percent organic titanate based on the weight of the primer solution.

14. The method of claim 1, wherein after said contacting the glazing prelaminate has an 180 degree T-peel between the functional film and the first shock dissipating layer in the range of about 10 to about 300 N/m.

15. The method of claim 1, wherein said contacting is at a speed in the range of about 1 cm/sec to about 150 cm/sec.

16. The method of claim 1, wherein the functional film has a second surface opposite the first surface and wherein said method further comprises:
applying a second organic titanate primer to the second surface of the functional film to form a second treated surface of the functional film; and
contacting so as to adhere together the second treated surface of the functional film and a second shock dissipating layer.

17. The method of claim 1, wherein the shock dissipating layer comprises an infrared reflective film and the shock dissipating layer comprises poly (vinyl butyral).

18. A method of making a glazing laminate comprising:
applying a first organic titanate primer to a first surface of a functional film to form a first treated surface of the functional film;
contacting so as to adhere together the first treated surface of the functional film and a first shock dissipating layer; and
bonding together a first transparent substrate and the first shock dissipating layer,
wherein the first shock dissipating layer is between the first treated surface of the functional film and the first transparent substrate.

19. The method of claim 18, wherein said method further comprises applying heat, applying pressure, or a combination thereof to at least one of the functional film, the first shock dissipating layer, or the first transparent substrate so as to form a glazing laminate.

20. The method of claim 18, wherein an 180 degree T-peel between the functional film and the first shock dissipating layer is in the range of about 10 to about 700 N/m.

21. The method of claim 18, wherein the functional film has a second surface opposite the first surface and said method further comprises:
applying a second organic titanate primer to the second surface of the functional film to form a second treated surface of the functional film;
contacting so as to adhere together the second treated surface of the functional film and a second shock dissipating layer; and
bonding together the second shock dissipating layer and a second transparent substrate,
wherein the second shock dissipating layer is between the second treated surface of the functional film and the second transparent substrate.

22. The method of claim 1, wherein the first organic titanate primer is applied in an amount in the range of about 1 μg/in² (0.2 μg/cm²) to about 30 μg/in² (6 μg/cm²).

23. A glazing prelaminate comprising
a functional film having a first surface treated with a first organic titanate primer to form a first treated surface; and
a first shock dissipating layer adhered to said first treated surface.

24. The glazing prelaminate of claim 23, wherein said functional film comprises an infrared reflective film, a ultraviolet reflective film, a safety film, a polarizing film, an anti-intrusive film, or a combination thereof.

25. The glazing prelaminate of claim 23, wherein the first surface of said functional film comprises a polyester, polyacrylate, ionomer, cellulose acetate, or a combination thereof.

26. The glazing prelaminate of claim 23, wherein said shock dissipating layer comprises a poly(vinyl butyral).

27. The glazing prelaminate of claim 23, wherein said first treated surface comprises at least one of titanium dioxide, titanium dioxide hydrate, or a polymeric titanium dioxide.

28. The glazing prelaminate of claim 23, wherein said functional film has an opposite surface treated with a second organic titanate primer to form a second treated surface and wherein the glazing prelaminate further comprises a second shock dissipating layer adhered to said second treated surface.

29. The glazing prelaminate of claim 23, wherein said functional film comprises a reflective infrared film, the first organic titanate primer comprises a tetra-alkyl titanate, and the first shock dissipating layer comprises a poly(vinyl butyral).

30. A glazing laminate comprising:
a functional film having a first surface treated with a first organic titanate primer to form a first treated surface; and
a first shock dissipating layer adhered to said first treated surface; and
a first transparent substrate bonded to said first shock dissipating layer, wherein
said first shock dissipating layer is between said functional film and said first transparent substrate.

31. The glazing laminate of claim 30, wherein said first treated surface comprises at least one of titanium dioxide, titanium dioxide hydrate, or a polymeric titanium dioxide.

32. The glazing laminate of claim 30, wherein said functional film has an opposite surface treated with a second organic titanate primer to form a second treated surface and wherein the glazing laminate further comprises:
a second shock dissipating layer adhered to said second treated surface; and
a second transparent substrate bonded to said second shock dissipating layer,
wherein said second shock dissipating layer is between said functional film and said second transparent substrate.

33. The glazing laminate of claim 30, wherein said functional film comprises a reflective infrared film, the first organic titanate primer comprises a tetra-alkyl titanate, said first shock dissipating layer comprises poly(vinyl butyral), and said first transparent substrate comprises glass.

34. A method comprising:
providing an organic titanate primer between a functional film and a shock dissipating layer; and
adhering together the functional film and the shock dissipating layer.

35. The method of claim 34, further comprising bonding together a transparent substrate and the shock dissipating layer, wherein the shock dissipating layer is between the functional film and the transparent substrate.

36. The method of claims 34, wherein the shock dissipating layer comprises poly (vinyl butyral), and the organic titanate primer comprises a titanate chelate, a tetra-alkyl titanate, or a combination thereof.

37. An article comprising a functional film adhered to a shock dissipating layer with an adhesion region between said functional film and said shock dissipating layer, wherein said adhesion region comprises a reacted organic titanate primer.

39. The article of claim 37, further comprising a transparent substrate bonded to said shock dissipating layer, wherein said shock dissipating layer is between said functional film and said transparent substrate.

39. The article of claims 37, wherein the shock dissipating layer comprises poly (vinyl butyral), and the reacted organic titanate primer comprises at least one of titanium dioxide, titanium dioxide hydrate, or a polymeric titanium dioxide.
